(19) United States
(12) Patent Application Publication
(10) Pub. No.: US 2026/0287104 A1
(43) Pub. Date: Sep. 24, 2026

(54) QUICK CONNECT ENDFORMED TUBE WITH COLLAR

(71) Applicant: Hutchinson Fluid Management Systems, Inc., Auburn Hills, MI (US)

(72) Inventors: Chase Tanner Perucca, Clinton Township, MI (US); Nithish Kumar Sundaramurthy, South Lyon, MI (US)

(73) Assignee: Hutchinson Fluid Management Systems, Inc., Auburn Hills, MI (US)

(21) Appl. No.: 19/084,945

(22) Filed: Mar. 20, 2025

(51) Int. Cl. F16L 37/084

(52) U.S. Cl. CPC F16L 37/0985

(57) ABSTRACT

An insertion part configured for receipt in a receiving part of a quick-connect assembly includes an endformed metal tube shaped to have a flanged section between a first cylindrical section configured to be inserted into the receiving part and a second cylindrical section, the flanged section extending radially outward from between the cylindrical sections; and a plastic collar fixed to the endformed metal tube by at least one protuberance that projects from a surface of the second cylindrical section and is received in a recess in the plastic collar to prevent movement of the collar relative to the endformed metal tube.

### FIELD OF THE DISCLOSURE

This disclosure relates to quick-connect end-formed tubes that can be easily inserted into and secured to a receiving part to form a quick-connect assembly, and more particularly to such quick-connect end-formed tubes having a collar with an anti-rotation feature that can ensure a proper rotational orientation of the end-formed tube with respect to the receiving part of the quick-connect assembly.

### BACKGROUND OF THE DISCLOSURE

Quick-connect coupling assemblies are ubiquitous in the automotive industry, typically used for making fluid conduit connections in various fluid conduit systems, including, but not limited to, air-conditioning lines, tire inflation devices, fuel lines, washer fluid lines and thermal management systems for cooling battery assemblies in electric vehicles. The quick-connect coupling assemblies generally include an insertion part or male member that is plugged into a socket or receiving part, with at least one sealing member, such as, but not limited to, an elastomeric O-ring, positioned between internal mating surfaces of the insertion part and the receiving part. A spring clip is typically used to secure the insertion part and receiving part together. Typically, the receiving part is provided with windows or apertures that allow the spring clip to engage grooves provided on the insertion part through the windows. In order to limit coupling of the insertion part to a particularly required or desired orientation, the insertion part can be provided with an axially-extending key like structure that can be received in a complementary groove provided in the receiving part to prevent rotation and improper orientation of the parts with respect to each other.

A known quick-connect coupling assembly that provides anti-rotation features is described in U.S. Pat. No. 11,754,206. This assembly relies on an annular array of surface irregularities formed on an inner surface of an auxiliary or collar component. The irregularities extend axially along the entire length of the collar to provide a frictional fit between an endformed tube and the collar.

It is desirable to provide a simpler design that provides a more robust, inexpensive, and easily manufactured product having a plastic collar that reduces cost, eliminates corrosion concerns, and is light in weight.

### SUMMARY OF THE DISCLOSURE

In certain aspects of this disclosure, an insertion part of a quick-connect coupling assembly includes an endformed metal tube and a collar that is fixed to the endformed metal tube such as by a single protuberance, by two diametrically opposed protuberances, or by three or more protuberences that can be uniformly spaced apart circumferentially along the mating surfaces. Each protuberance projects from an outer surface of the endformed metal tube and is received in a recess or opening in the collar to prevent rotation of the collar with respect to the endformed metal tube and to prevent both axial and rotational movement of the collar with respect to the endformed metal tube.

In other aspects of this disclosure, an insertion part is made by shaping an end of a metal tube to have a flanged section between a first cylindrical section that is configured to be inserted into a receiving part of a quick-connect coupling assembly and a second cylindrical section configured to retain a collar; sliding the collar over the second cylindrical section; and forming a protuberance on the second cylindrical section that projects into a recess or opening in the collar to fix the position and orientation of the collar relative to the shaped metal tube. A third cylindrical section between the flanged section and the second cylindrical section can be provided for receiving a spring clip for holding the insertion part on a receiving part.

In a further aspect of this disclosure, an insertion part is made by shaping an end of a metal tube to have a flanged section between a first cylindrical section that is configured to be inserted into a receiving part of a quick-connect coupling assembly and a second cylindrical section configured to retain a plastic collar; forming a protuberance on the second cylindrical section; and molding the plastic collar over a portion of the second cylindrical section that includes the protuberance.

### BRIEF DESCRIPTION OF THE DRAWINGS

FIG. 1 is a perspective view of a first embodiment of an endformed metal tube of an insertion part of a quick-connect assembly in accordance with this disclosure.

FIG. 2 is a perspective view of a collar used with the endformed metal tube of FIG. 1 to form the insertion part.

FIG. 3 is a side view of the collar of FIG. 2 retained on the endformed metal tube of FIG. 1 to provide the insertion part.

FIG. 4 is a perspective view of an alternative collar used with the endformed metal tube to provide an alternative embodiment of an insertion part in accordance with this disclosure.

FIG. 5 is a perspective view of the collar of FIG. 4 retained on the endformed metal tube of FIG. 1 to provide the alternative insertion part.

FIG. 6 is a side view of the insertion part shown in FIG. 5.

FIG. 7 is a cross-sectional side view of the insertion part shown in FIGS. 5 and 6.

FIG. 8 is a cross-sectional side view of an insertion part in accordance with this disclosure received in a receiving part to form a quick-connect coupling.

### DETAILED DESCRIPTION OF THE DISCLOSED EMBODIMENTS

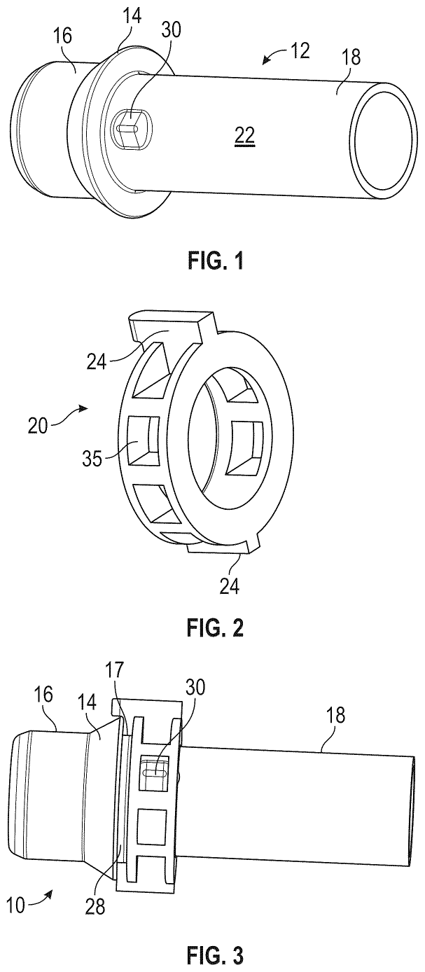

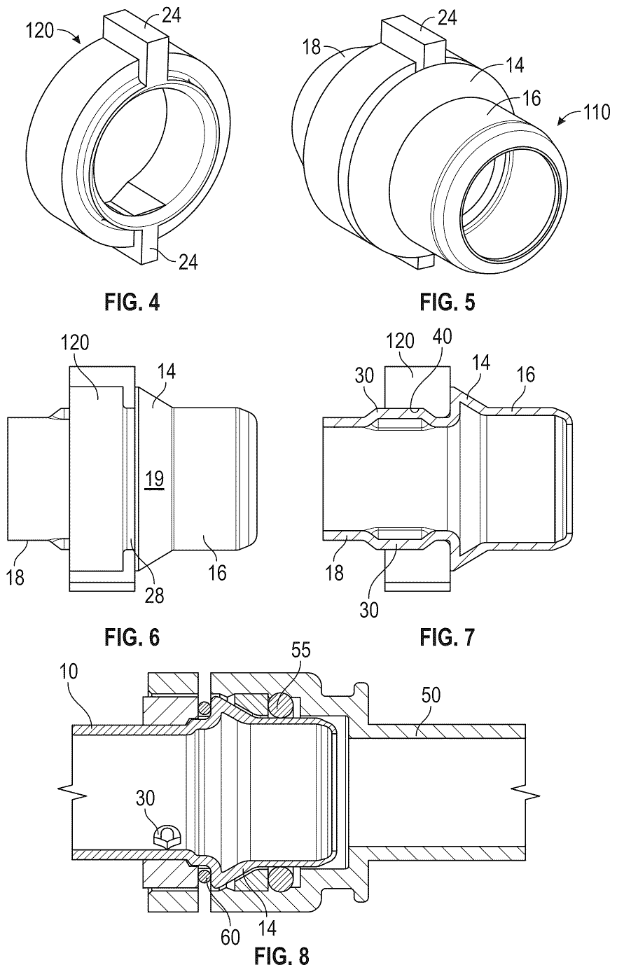

The insertion parts 10 (FIGS. 3) and 110 (FIGS. 5-7) of this disclosure generally comprise an endformed metal tube 12 (FIG. 1) and a collar 20 (FIG. 2) or 120 (FIG. 4) retained on the endformed metal tube by a protuberance 30 that projects away from an outer surface of endformed metal tube 12 and into an opening 35 of collar 20 or recess 40 of collar 120. Endformed metal tube 12 is prepared by shaping or deforming an end of a metal pipe using any of various endforming processes utilizing hydraulic, pneumatic or electric endforming tools such as punch dies that progressively form the tube into a desired configuration. Suitable metal tubes include those made of aluminum, steel, bronze, copper or other metals or metal alloys.

In the illustrated embodiments, the endformed metal tube 12 is shaped to have a flanged section 14 located between a first cylindrical section 16 configured to be inserted into a receiving part or socket of a quick-connect coupling assembly and a second cylindrical section 18 configured to retain collar 20 or collar 120. Flanged section 14 can have a frustoconical shape (as illustrated in FIGS. 1, 3 and 5-7) defining a circumferential surface 19 that is sloped radially outwardly (i.e., has an increasing diameter) moving from section 16 to section 18.

Protuberance 30 or a pair of diametrically opposed (180 degrees apart circumferentially) protuberances projecting from surface 22 of cylindrical section 18 can be designed and implemented to fix the position and orientation of collar 20 or 120 relative to tube 12 to prevent rotation and axial movement of the collar with respect to the tube. It is also possible to utilize two or more protuberances that are not necessarily diametrically opposed. For example, three protuberances can be distributed circumferentially (e.g., 120 degrees apart) or four protuberances can be distributed circumferentially (e.g., 90 degrees apart).

Collar 20 or 120 can be provided with one or more anti-rotation structures or keys 24 configured to be received into a conforming groove on the receiving part to prevent rotation of insertion part 10 or 110 relative to the receiving part and/or to prevent improper orientation of the insertion part relative to the receiving part.

Collar 20 or 120 can be retained in a position adjacent to flanged section 14 and can be configured to have a short cylindrical section 17 between flanged section 14 and cylindrical section 18 that defines a groove 28 that extends along at least a portion of the circumference of the collar.

In accordance with certain aspects of this disclosure, the insertion part 10 can be made by a process of endforming (shaping an end) metal tube 12 to have flanged section 14 between cylindrical sections 16 and 18, sliding collar 20 over the second cylindrical section 18 so that at least a portion of the collar abuts section 14, and forming protuberance 30 on section 18 so that it projects into opening 35, thereby fixing the position and orientation of the collar relative to tube 12.

In accordance with certain other aspects of this disclosure, the insertion part 110 can be made by deep draw metal stamping or other process of endforming metal tube 12 to have a flanged section 14 between cylindrical sections 16 and 18, forming protuberances 30 on section 18, and molding plastic collar 120 over a portion of cylindrical section 18 that includes protuberances 30.

Collars 20, 120 can be made of any of various thermoplastic polymers, such as, but not limited to, polyamide (e.g., Nylon 66), polyphthalamide (PPA), polypropylene, polyethylene, and acrylonitrile-butadiene-styrene terpolymer, or any of various metals, such as, but not limited to aluminum, copper, bronze and steel.

FIG. 8 shows insertion part 10 received in a receiving part 50. An elastomeric O-ring 55 provides a seal between parts 10 and 50, and a spring clip 60 locks parts 10 and 50 together.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments. Thus, the invention is capable of modification and variation and is limited only by the following claims.

1. An insertion part configured for receipt in a receiving part of a quick-connect assembly, the insertion part comprising:
an endformed metal tube shaped to have a flanged section between a first cylindrical section configured to be inserted into the receiving part and a second cylindrical section, the flanged section extending radially outwardly from between the first cylindrical section and the second cylindrical section; and
a collar fixed to the endformed metal tube by at least one protuberance, each protuberance projecting from a surface of the second cylindrical section and received in a recess or opening in the collar to prevent rotation of the collar with respect to the endformed metal tube and to prevent axial movement of the collar with respect to the endformed metal tube.

2. The insertion part of claim 1, wherein the plastic collar is positioned and configured to define a groove extending at least partially along a circumference of the cylindrical section of the shaped tube adjacent an end of the flanged section.

3. The insertion part of claim 1, wherein the collar has at least one anti-rotation key configured to be received in a conforming groove on the receiving part.

4. The insertion part of claim 1, wherein the collar has two or more anti-rotation keys.

5. The insertion part of claim 1, wherein the collar has two anti-rotation keys diametrically opposed along a circumference of the collar.

6. The insertion part of claim 1, wherein the flanged section has a frustoconical shape defining a circumferential surface that is sloped radially outwardly from the first cylindrical section to the second cylindrical surface.

7. A process for making the an insertion part of claim 1, comprising:
forming a metal tube having a flanged section between a first cylindrical section configured to be inserted into the receiving part and a second cylindrical section, with the flanged section extending radially outwardly from between the first cylindrical section and the second cylindrical section;
sliding a collar over the second cylindrical section of the shaped metal tube, the collar having at least one recess or opening; and
forming at least one protuberance on the second cylindrical section, each protuberance projecting into a recess or opening of the collar to fix the position of the collar relative to the shaped metal tube.

8. The process of claim 7, wherein the collar is positioned and configured to define a groove extending at least partially along a circumference of the cylindrical section of the shaped tube adjacent an end of the flanged section.

9. The process of claim 7, wherein the collar has at least one anti-rotation key configured to be received in a conforming groove on the receiving part.

10. The process of claim 7, wherein the collar has two anti-rotation keys.

11. The process of claim 10, wherein the two anti-rotation keys are diametrically opposed along a circumference of the collar.

12. The process of claim 7, wherein the flanged section has a frustoconical shape defining a circumferential surface that is sloped radially outwardly from the first cylindrical section to the second cylindrical surface.

13. A process for making the an insertion part of claim 1, comprising:
shaping an end of a metal tube to have a flanged section between a first cylindrical section configured to be inserted into the receiving part and a second cylindrical section, with the flanged section extending radially outwardly from between the first cylindrical section and the second cylindrical section;
forming at least one protuberance on the second cylindrical section; and
molding a plastic collar over a portion of the second cylindrical section that includes the protuberance.

14. The process of claim 13, wherein the plastic collar is positioned and configured to define a groove extending at least partially along a circumference of the cylindrical section of the shaped tube adjacent an end of the flanged section.

15. The process of claim 13, wherein the collar has at least one anti-rotation key configured to be received in a conforming groove on the receiving part.

16. The process of claim 15, wherein the plastic collar has two anti-rotation keys.

17. The process of claim 16, wherein the two anti-rotation keys are diametrically opposed along a circumference of the collar.

18. The process of claim 13, wherein the flanged section has a frustoconical shape defining a circumferential surface that is sloped radially outwardly from the first cylindrical section to the second cylindrical surface.
